(19) United States
(12) Patent Application Publication
(10) Pub. No.: US 2026/0122607 A1
(43) Pub. Date: Apr. 30, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: TAIGA ONDA, Chiba (JP)

(21) Appl. No.: 19/432,516

(22) Filed: Dec. 24, 2025

Related U.S. Application Data
(63) Continuation of application No. PCT/JP2024/022481, filed on Jun. 21, 2024.

(30) Foreign Application Priority Data
Jul. 6, 2023 (JP) 2023-111723

(51) Int. Cl. H04W 64/00

(52) U.S. Cl. CPC H04W 64/00

(57) ABSTRACT

A communication apparatus that functions as a mobile Integrated Access and Backhaul (IAB) node includes an acquisition unit configured to acquire position information of the communication apparatus, reception unit configured to receive a control plane signal including area information, and a determination unit configured to determine whether to provide a communication service to another communication apparatus based on the acquired position information and the received area information.

### Cross-Reference to Related Applications

This application is a Continuation of International Patent Application No. PCT/JP2024/022481, filed June 21, 2024, which claims the benefit of Japanese Patent Application No. 2023-111723, filed July 6, 2023, both of which are hereby incorporated by reference herein in their entirety.

### BACKGROUND

### Field of Technology

The present disclosure relates to a communication apparatus, a control method, and a storage medium.

### Description of the Related Art

The 3rd Generation Partnership Project (3GPP)® is currently working on standardizing IAB as a communication technique for backhaul. IAB is an abbreviation for Integrated Access and Backhaul.

The IAB technique is a technique for simultaneously using millimeter wave wireless communication at the 28 GHz band or the like used for access communication between a base station and user equipment (UE) as backhaul communication (Japanese Unexamined Patent Application Publication No. 2019-534625).

In backhaul communications using the IAB technique, repeaters called IAB nodes relay communications from IAB donors, which are base stations, using millimeter-wave communications. Using the IAB technology makes it possible to expand area coverage at a low cost compared to conventional wired communications using optical fibers or the like.

So far, 3GPP® has formulated specifications for fixed base stations (IAB nodes that do not move) up to Rel-17.

Currently, 3GPP® is planning to actively discuss the vehicle mounted relay that will be a use case in the next Rel-18 and the mobile IAB to formulate specifications for realizing the use case.

It is thus considered that various requirements will emerge that cannot be satisfied with the specifications that have been discussed based on fixed base stations.

One of the discussion topics is "Authorization and Configuration of Mobile Base Station Relay", which envisions mobile IAB nodes temporarily installed in vehicles and acting as repeaters to provide services to UEs in urban environments or during large-scale events in designated areas to achieve special coverage and connectivity.

A use case is that when a mobile IAB node is present within a specific area, the mobile IAB node provides services to nearby UEs, and when the mobile IAB node moves outside of the specific area, the mobile IAB node stops providing services.

In this regard, there is known a technique for providing services by utilizing position information and movement information of mobile nodes (Japanese Unexamined Patent Application Publication No. 2009-501453).

In the case of determining whether to stop service provision depending on whether a mobile IAB node has moved outside of a specific area, it is useful for the communication system to determine how the specific area is defined by the mobile IAB node.

### SUMMARY

The present disclosure has been made in view of at least one of the above-described issues. An aspect of the present disclosure is directed to providing a mechanism that enables a mobile Integrated Access and Backhaul (IAB) node to recognize each specific area.

According to an aspect of the present disclosure, a communication apparatus that functions as a mobile Integrated Access and Backhaul (IAB) node includes an acquisition unit configured to acquire position information of the communication apparatus, reception unit configured to receive a control plane signal including area information, and a determination unit configured to determine whether to provide a communication service to another communication apparatus based on the acquired position information and the received area information.

Features of the present disclosure will become apparent from the following description of embodiments with reference to the attached drawings.

### BRIEF DESCRIPTION OF THE DRAWINGS

FIG. 1 is a hardware block diagram of an Integrated Access and Backhaul (IAB) node.

FIG. 2 is a software functional block diagram of the IAB node.

FIG. 3A is a typical Radio Resource Control (RRC) Setup sequence diagram in the 3GPP® standard.

FIG. 3B is a typical RRC Reconfiguration sequence diagram in the 3GPP® standard.

FIG. 4A is an example diagram (part 1) of a communication permitted area format in an embodiment.

FIG. 4B is an example diagram (part 2) of the communication permitted area format in the embodiment.

FIG. 4C is an example diagram (part 3) of the communication permitted area format in the embodiment.

FIG. 4D is an example diagram (part 4) of the communication permitted area format in the embodiment.

FIG. 5 is a flowchart of processing at the time of reception of an RRC Setup message including communication permitted area information in a first embodiment.

FIG. 6 is a flowchart of processing at the time of reception of an RRC Reconfiguration message including communication permitted area information in the first embodiment.

FIG. 7 is a flowchart of processing at the time of reception of an RRC Setup message including communication permitted area information in a second embodiment.

### DESCRIPTION OF THE EMBODIMENTS

Hereinafter, embodiments will be described in detail with reference to the accompanying drawings. In the following description, the "number ***" in TS*** represents the number of the technical specification in the 3GPP® standard.

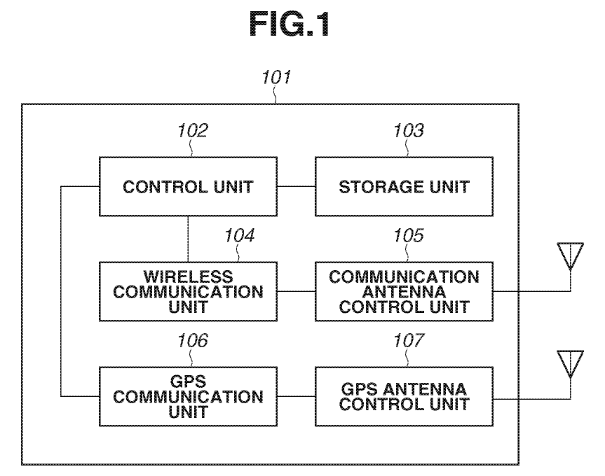

FIG. 1 is a block diagram illustrating an example of hardware configuration of a mobile Integrated Access and Backhaul (IAB) node according to an embodiment. A mobile IAB node, which is typified by a mobile IAB node 101 or the like, is also referred to as a mobile base station relay (MBSR).

The hardware configuration of the mobile IAB node 101 includes a control unit 102, a storage unit 103, a wireless communication unit 104, a communication antenna control unit 105, a global positioning system (GPS) communication unit 106, and a GPS antenna control unit 107.

The control unit 102 controls the entire apparatus by executing control programs stored in the storage unit 103. The control unit 102 includes one or more processors, such as a central processing unit (CPU), a micro processing unit (MPU), and the like, and controls the entire communication apparatus by executing a control program read into a random access memory (RAM), which is the storage unit 103. Processing performed by the control unit 102, which will be described below with reference to the flowcharts, can also be implemented using a hardware circuit such as an ASIC or an FPGA. ASIC is an abbreviation for Application Specific Integrated Circuit. FPGA is an abbreviation for Field Programmable Gate Array. The processing described below with reference to the flowcharts can also be implemented by cooperation between a hardware circuit and a processor such as a CPU or an MPU.

The storage unit 103 stores the control programs executed by the control unit 102, and various types of information such as cell information, connection terminal information, IAB routing information, and position information. The storage unit 103 may include a main storage unit and an auxiliary storage unit. The main storage unit is, for example, a read only memory (ROM) or a RAM. The main storage unit may store or temporarily save data and programs, such as an operating system (OS), which is basic software executed by the control unit 102, and application software. The auxiliary storage unit is, for example, a hard disk drive (HDD) or a solid state drive (SSD), and may store data related to application software and the like. For example, the control program stored in the non-volatile storage area is developed into the RAM and executed by a processor constituting the control unit 102. In this way, the control unit 102 and the storage unit 103 may function as a computer.

The wireless communication unit 104 performs cellular network communication such as Long Term Evolution (LTE) or 5G New Radio (NR) that conforms to the 3GPP® standard.

The communication antenna control unit 105 controls an antenna (not illustrated) for wireless communication performed by the wireless communication unit 104.

The GPS communication unit 106 receives satellite signals from GPS satellites to acquire current position information including position identification information such as longitude and latitude information, and current time information. The GPS communication unit 106 may have a function of measuring (determining) the current position based on the satellite signals. Another Global Navigation Satellite System (GNSS) may also be used instead of or in addition to GPS.

The GPS antenna control unit 107 controls an antenna (not illustrated) for GPS communication performed by the GPS communication unit 106.

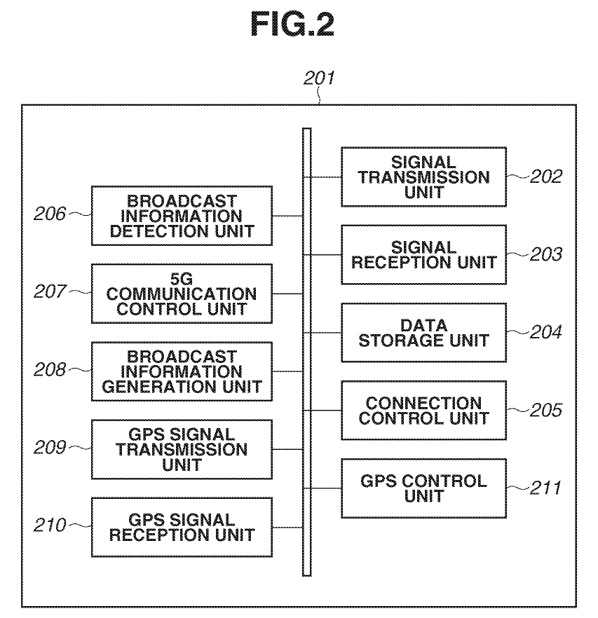

FIG. 2 is a block diagram illustrating an example of configuration of software functional blocks of a mobile IAB node that executes communication control functions.

A software function 201 related to the IAB node includes a signal transmission unit 202, a signal reception unit 203, a data storage unit 204, a connection control unit 205, a broadcast information detection unit 206, a 5G communication control unit 207, and a broadcast information generation unit 208. The software function 201 also includes a GPS signal transmission unit 209, a GPS signal reception unit 210, and a GPS control unit 211.

The signal transmission unit 202 and the signal reception unit 203 perform cellular network communication such as LTE or 5G, which conforms to the 3GPP® standard, with user equipment (UE). The control plane signal is received by the signal reception unit 203.

The data storage unit 204 stores and holds the software itself, IAB routing information, information about connected UEs, position information, movement path information, and the like.

The connection control unit 205 controls the antenna for wireless communication performed by the wireless communication unit 104.

The broadcast information detection unit 206 detects broadcast information from neighboring IAB nodes. The broadcast information may be a synchronization signal/ Physical Broadcast Channel (PBCH) block (SSB).

The 5G communication control unit 207 connects to and disconnects from the 5G network. The 5G communication control unit 207 also causes the node 101 to function as an IAB-Distributed Unit (DU) described below, provides wireless layer communication services to a UE, and provides a relay function to relay communication between the UE and the 5G network. Although the description here is about 5G, it is also applicable to other techniques (e.g., 5G Advanced, 6G, or the like) as described above, and the same applies hereinafter.

The broadcast information generation unit 208 generates broadcast information for broadcasting the appearance (existence) of the IAB node101 itself.

The GPS signal transmission unit 209 and the GPS signal reception unit 210 perform communication in conformity with the GPS standard.

The GPS control unit 211 controls the antenna for GPS communication performed by the GPS communication unit 106. The GPS control unit 211 also calculates the current position and time from the received GPS information. At this time, the GPS control unit 211 outputs various calculation results in a format such as National Marine Electronics Association (NMEA)-0183. The GPS control unit 211 may also perform a process of saving various calculation results (e.g., the current position and time) in the data storage unit 204 as necessary.

Next, a method for defining a specific area for a mobile IAB node in the present embodiment will be described.

In the present embodiment, the area indicated by information transmitted using a control plane signal in a 5G system will be defined as a communication permitted area (an example of a specific area) in which a mobile IAB node can operate.

Specifically, the control plane signal is an RRC message. RRC is an abbreviation for Radio Resource Control. More specifically, the control plane signal can be transmitted using an RRC Setup message and/or an RRC Reconfiguration message in the RRC message.

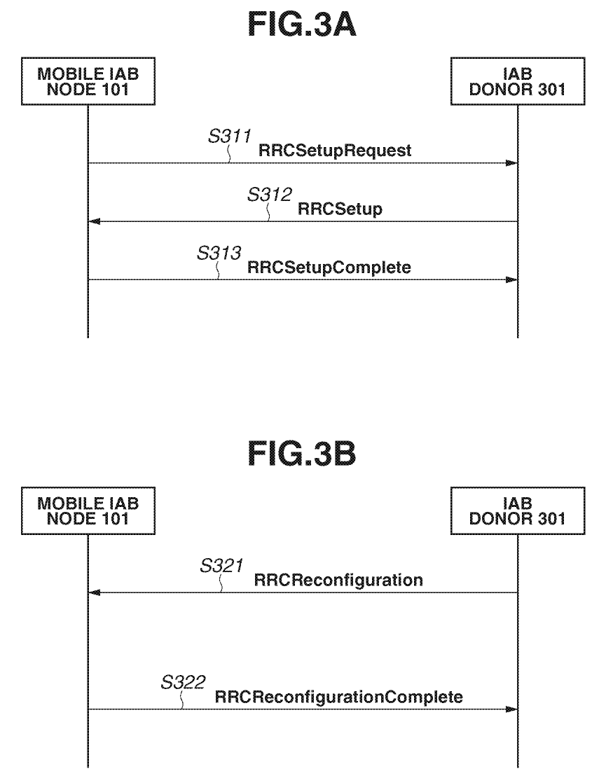

FIG. 3A illustrates a typical RRC Setup message sequence specified in TS 38.331, and FIG. 3B illustrates a typical RRC Reconfiguration message sequence specified in TS 38.331.

The communication related to the RRC Setup message illustrated in FIG. 3A is performed in the RRC connection establishment process for a mobile IAB node to join the network.

First, in step S311, the mobile IAB node 101 transmits an RRC SetupRequest message to the IAB donor 301. Upon receipt of the message, in step S312, the IAB donor 301 transmits an RRC Setup message in the case of allowing the mobile IAB node 101 to join the network.

At this time, the IAB donor 301 transmits information indicating the communication permitted area added to the message. Upon receipt of the message, the mobile IAB node 101 performs a process for joining the network based on the information included in the RRC Setup message and responds with an RRC SetupComplete message in step S313.

Communication related to the RRC Reconfiguration message illustrated in FIG. 3B is performed in an RRC reconfiguration process for changing the information set in the mobile IAB node.

First, in step S321, the IAB donor 301 transmits an RRC Reconfiguration message to the mobile IAB node 101. At this time, the IAB donor 301 transmits information indicating the communication permitted area added to this message. Upon receipt of the message, the mobile IAB node 101 performs an RRC reconfiguration process based on the information included in the RRC Reconfiguration message.

After completion of the RRC reconfiguration process, in step S322, the mobile IAB node 101 responds with an RRC ReconfigurationComplete message.

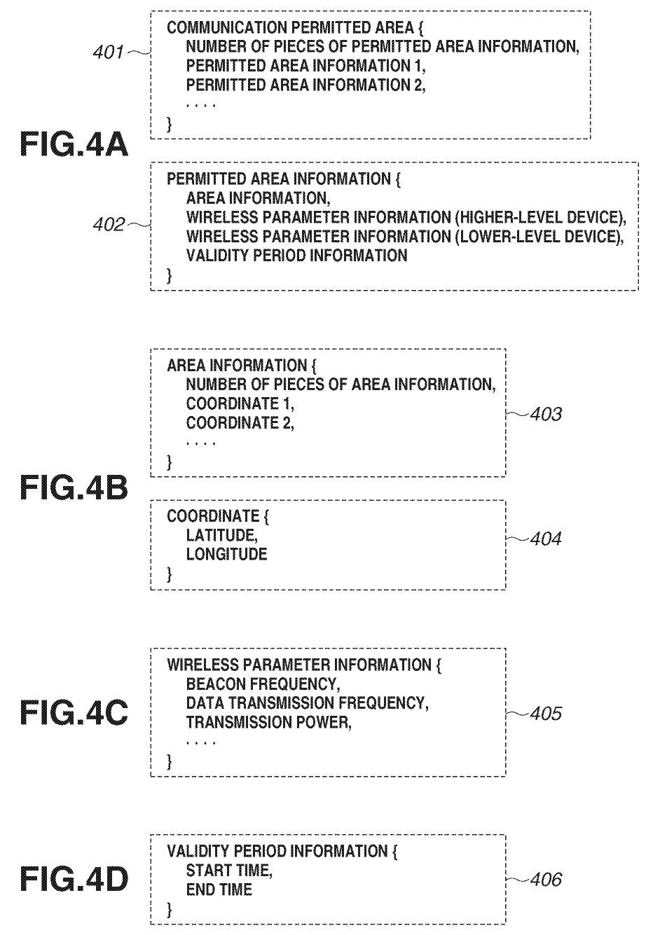

FIGS. 4A to 4D illustrate various examples of a communication permitted area format 401 included in the RRC Setup message and the RRC Reconfiguration message.

FIG. 4A illustrates an example of the communication permitted area format 401. The communication permitted area format 401 is a basic format that indicates a communication permitted area in which the mobile IAB node can operate.

This information may be incorporated as a new field into the RRC Reconfiguration message field or the RRC Setup message field specified in TS 38.331. This information is provided to the mobile IAB node.

The communication permitted area is composed of the number of pieces of permitted area information and the permitted area information.

The number of pieces of permitted area information includes the number of pieces of permitted area information included in the message.

The permitted area information is stored in correspondence with the number of pieces of permitted area information such as permitted area information 1, permitted area information 2, and so on. A mobile IAB node can provide services within one or more permitted areas indicated by the permitted area information. Although one piece of permitted area information here is information related to one permitted area, one piece of permitted area information may be information related to two or more permitted areas. The unit of permitted area may be a set of physically contiguous areas. The permitted areas may be separated every time any one of wireless parameter information (high-level device), wireless parameter information (low-level device), and validity period information described below, is different.

The services provided by the mobile IAB node within the permitted area refer to various communication services provided by the IAB node to the UE, for example. In this case, the concept of communication services includes creating a state in which access from the UE can be accepted. In other words, providing communication services can also be considered a concept that includes making the mobile IAB node function as an IAB-DU and providing a state in which the UE can access. On the other hand, not providing services can also be considered a concept that includes not making the mobile IAB node function as an IAB-DU and not providing a radio access network (RAN) to the surrounding area.

In the example illustrated in FIG. 4A, the permitted area information format 402 constitutes a configuration example of the permitted area information 1. The same may be applied to the permitted area information 2 and the like.

The permitted area information 1 includes area information, wireless parameter information (high-level device), wireless parameter information (low-level device), and validity period information.

FIG. 4B illustrates an example of area information 403. In the example illustrated in FIG. 4B, the area information 403 includes the number of pieces of area information and coordinates.

The number of pieces of area information includes the number of coordinate points that form a coordinate group included in the message.

One coordinate point includes latitude and longitude information (a set of coordinates) as illustrated in a format 404. The format 404 will be described here. The latitude and longitude information stored here may be coded in 24 bits each, in accordance with the coordinate information representation format specified in TS23.032.

Such coordinate points are stored in accordance with the number of pieces of area information. The area connecting these coordinate points may be treated as a communication permitted area in which the mobile IAB node can operate.

FIG. 4C illustrates an example of a wireless parameter information format 405. The wireless parameter information format 405 relates to the wireless parameter information (high-level device) and wireless parameter information (low-level device) of the permitted area information format 402. The wireless parameter information (high-level device) and wireless parameter information (low-level device) of the permitted area information format 402 each indicate wireless parameters for operating the mobile IAB node in the associated communication permitted area.

Various parameters related to wireless settings are included in the wireless parameter information format 405. The various parameters related to wireless settings can include, but are not limited to, a beacon frequency, a data transmission frequency, a transmission power, and the like.

The setting values of various parameters related to wireless settings are used for wireless operation settings of the mobile IAB node. Specifically, the wireless settings set in the wireless parameter information (high-level device) are applied as wireless settings for a device that is a high-level device of the mobile IAB node. The device that is a high-level device of the mobile IAB node may be an IAB donor or the like. Furthermore, the wireless settings in the wireless parameter information (low-level device) are applied as wireless settings for a device that is a low-level device of the mobile IAB node. The device that is a low-level device of the mobile IAB node may be a UE or the like.

As examples of various parameters related to wireless settings, beacon frequency, a data transmission frequency, transmission power, and the like have been cited. However, the present disclosure is not limited to these. For example, various parameters related to wireless settings may include SL-V2X-Preconfiguration parameters and SL-Preconfiguration NR parameters indicated in TS36.331. Furthermore, wireless parameters for mobile IAB may also be used by establishing new parameters in the future instead of or in addition to SL-Preconfiguration NR.

The validity period information includes a start time and an end time, as indicated by reference numeral 406 in FIG. 4D. This information is used to set the time at which the permitted area associated with the validity period information becomes valid. For example, the information can be set by storing as a character string such as YYYY-MM-DD HH:MM:SS, or in accordance with the time information format used in SIB9 specified in TS 38.331.

Specific examples of communication permitted area formats have been provided so far, but other formats are also possible. For example, the wireless parameter information (high-level device), the wireless parameter information (low-level device), and the validity period information included in the permitted area information specified in the permitted area information format 402 may be optional information in this format. Furthermore, if no specific wireless settings associated with the set permitted area are required, this field may not be included. Similarly, if no validity period for the permitted area is required, this field may not be included.

Next, a flow of processing will be described in which the mobile IAB node 101 receives an RRC Setup message including communication permitted area information and an RRC Reconfiguration message including communication permitted area information.

The communication permitted area format in the present embodiment includes the wireless parameter information (high-level device), the wireless parameter information (low-level device), and the validity period information, which are defined as optional information as described above.

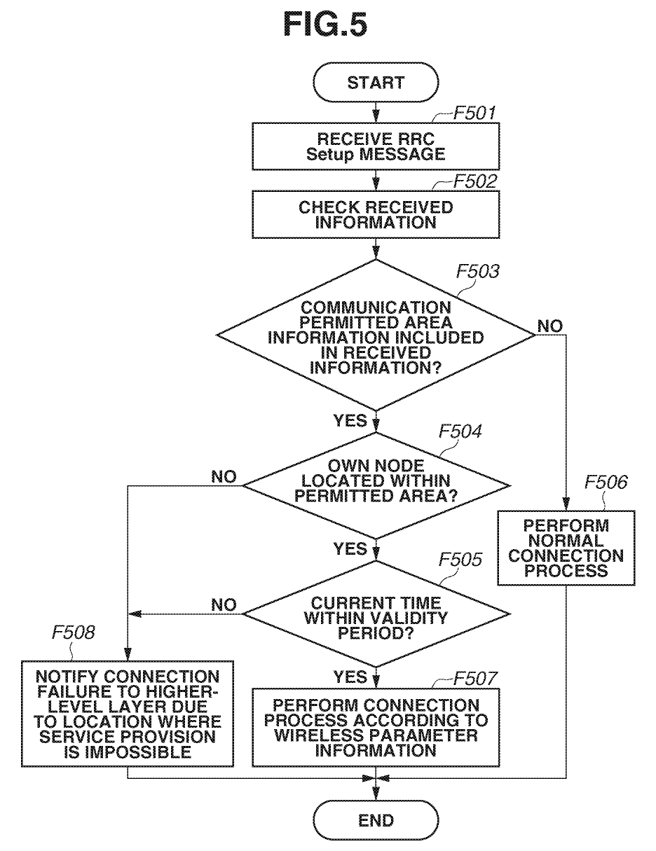

FIG. 5 is a flowchart of processing at the time of reception of an RRC Setup message including communication permitted area information.

In step F501, the mobile IAB node 101 receives an RRC Setup message from the IAB donor 301.

Next, in step F502, the mobile IAB node 101 checks the received RRC Setup message, and in step F503, the mobile IAB node 101 determines whether the received message includes a communication permitted area format.

If the mobile IAB node 101 determines that the received message does not include a communication permitted area format (NO in step F503), the processing proceeds to step F506. In step F506, the mobile IAB node 101 follows other information included in the RRC Setup message. In this case, the mobile IAB node 101 performs the normal connection process after reception of the RRC Setup message specified in TS 38.331.

If the mobile IAB node 101 determines that the received message includes a communication permitted area format (YES in step F503), the processing proceeds to step F504. In step F504, the mobile IAB node 101 determines whether the IAB node 101 itself is located inside the communication permitted area.

The position information of the IAB node 101 itself used for this determination is determined based on GPS information received via the GPS antenna control unit 107, the GPS communication unit 106, and the GPS signal reception unit 210. In addition, from the coordinate group indicated in the permitted area information stored in the received communication permitted area format, the range formed by connecting the coordinates is extracted as the communication permitted area and is used for this determination.

The mobile IAB node 101 compares the position information of the IAB node 101 itself determined by the above process with the communication permitted area to determine whether the IAB node itself is located inside or outside the communication permitted area.

If the mobile IAB node 101 determines that the position of the IAB node 101 itself is outside the permitted area (NO in step F504), the mobile IAB node 101 cannot provide service. Thus, in this case, in step F508, the mobile IAB node 101 notifies the IAB donor 301 of a connection failure and stops the processing related to the RRC Setup process specified in TS 38.331.

If the mobile IAB node 101 determines that the position of the IAB node 101 itself is inside the permitted area (YES in step F504), the processing proceeds to step F505. In step F505, the mobile IAB node 101 determines whether the current time is within the validity period of the specified communication permitted area.

The current time information of the IAB node 101 itself used for this determination is determined based on GPS information received via the GPS antenna control unit 107, the GPS communication unit 106, and the GPS signal reception unit 210.

If the mobile IAB node 101 determines that the current time is outside the validity period of the specified communication area (NO in step F505), the mobile IAB node 101 is located inside the area but cannot provide services because the validity period has expired. Thus, in this case, in step F508, the mobile IAB node 101 notifies the IAB donor 301 of a connection failure, and stops the processing related to the RRC Setup process specified in TS 38.331.

If the mobile IAB node 101 determines that the current time is within the validity period of the specified communication-permitted area (YES in step F505), the mobile IAB node 101 performs a process of connection with the IAB donor 301 serving as the high-level device, and provides a beacon broadcast to the UE serving as the low-level device. At this time, in step F507, the mobile IAB node 101 uses the wireless parameter information (high-level device) and the wireless parameter information (low-level device) linked to the permitted area information stored in the communication permitted area format.

The above is the sequence of processing performed by the mobile IAB node 101 in the present embodiment at the time of reception of an RRC Setup message including communication permitted area information.

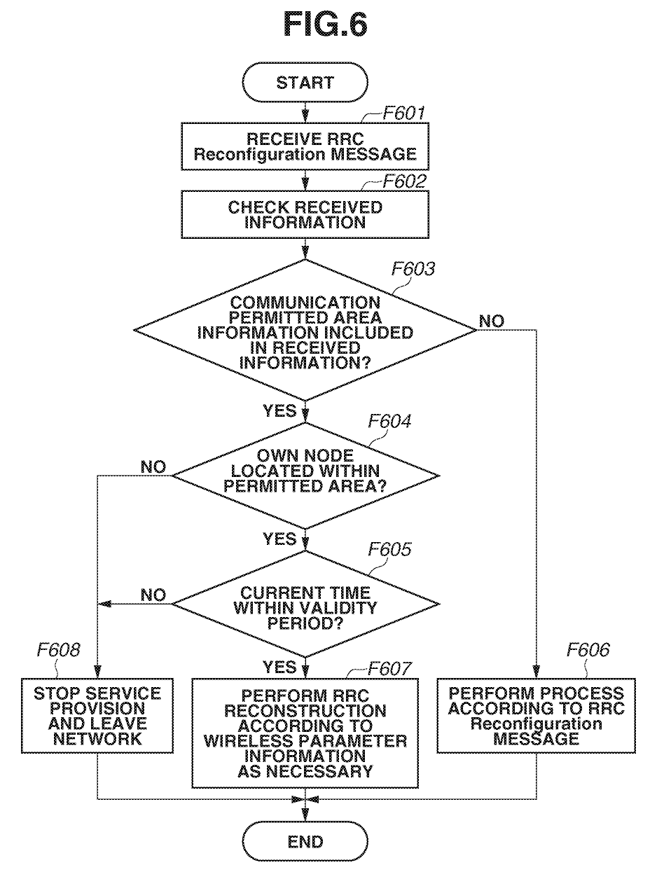

FIG. 6 is a flowchart of processing at the time of reception of the communication permitted area format 401 in an RRC Reconfiguration message.

In step F601, the mobile IAB node 101 receives an RRC Reconfiguration message from the IAB donor 301.

Next, in step F602, the mobile IAB node 101 checks the received RRC Reconfiguration message, and in step F603, the mobile IAB node 101 determines whether the received message includes a communication permitted area format.

If the mobile IAB node 101 determines that the received message does not include a communication permitted area format (NO in step F603), the processing proceeds to step F606. In step F606, the mobile IAB node 101 follows other information included in the RRC Reconfiguration message. In this case, the mobile IAB node 101 performs the normal process after receiving the RRC Reconfiguration message specified in TS 38.331.

If the mobile IAB node 101 determines that the received message includes a communication permitted area format (YES in step F603), the processing proceeds to step F604. In step F604, the mobile IAB node 101 determines whether the position of the IAB node 101 itself is within the communication permitted area.

The position information of the IAB node 101 itself used for this determination is determined based on GPS information received via the GPS antenna control unit 107, the GPS communication unit 106, and the GPS signal reception unit 210. From the coordinate group indicated in the permitted area information stored in the received communication permitted area format, the range formed by connecting the coordinates as the communication permitted area is also extracted and used for this determination.

The mobile IAB node 101 compares the position information of the IAB node 101 itself determined by the above process with the communication permitted area to determine whether the IAB node 101 itself is located inside or outside the communication permitted area.

If the mobile IAB node 101 determines that the position of the IAB node 101 itself is outside the permitted area (NO in step F604), the mobile IAB node 101 outside the area cannot provide service. Accordingly, in step F608, the mobile IAB node 101 stops (ends) the service provision and leaves the network.

If the mobile IAB node 101 determines that the position of the IAB node 101 itself is inside the permitted area (YES in step F604), the processing proceeds to step F605. In step F605, the mobile IAB node 101 determines whether the current time is within the validity period of the specified communication permitted area.

The current time information of the IAB node 101 itself used for this determination is determined based on GPS information received via the GPS antenna control unit 107, the GPS communication unit 106 and the GPS signal reception unit 210.

If the mobile IAB node 101 determines that the current time is outside the validity period of the specified communication permitted area (NO in step F605), the mobile IAB node 101 is within the area but cannot provide services because the validity period has expired. Thus, in step F608, the mobile IAB node 101 suspends the service provision and leaves the network.

If the mobile IAB node 101 determines that the current time is within the validity period of the specified communication permitted area (YES in step F605), the processing proceeds to step F607. In step F607, the mobile IAB node 101 uses the wireless parameter information (high-level device) and wireless parameter information (low-level device) linked to the permitted area information stored in the communication permitted area format.

The above is the sequence of processing performed by the mobile IAB node 101 in the present embodiment at the time of reception of an RRC Reconfiguration message including communication permitted area information.

### Second Embodiment

The first embodiment described above is based on the assumption that the communication permitted area format includes the wireless parameter information (high-level device), the wireless parameter information (low-level device), and the validity period information, which are defined as optional information above. The operations performed by the mobile IAB node 101 at the time of reception of an RRC Setup message or an RRC Reconfiguration message including the communication permitted area information have been described.

A second embodiment will be described as an embodiment without such assumption. In the second embodiment, it is additionally determined whether wireless parameter information (high-level device), wireless parameter information (low-level device), and validity period information defined as the optional information described above are included.

In the present embodiment, an RRC Setup message is taken as an example, but the same determination may also be made for an RRC Reconfiguration message.

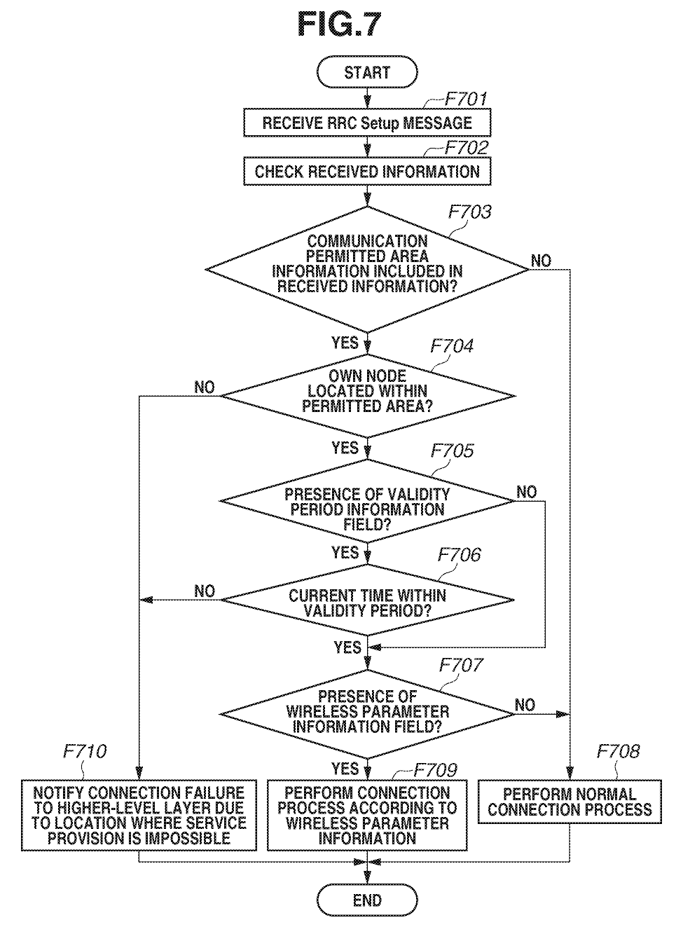

FIG. 7 illustrates a flowchart of processing performed by a mobile IAB node 101 at the time of reception of an RRC Setup message including communication permitted area information in the present embodiment.

First, in step F701, the mobile IAB node 101 receives an RRC Setup message from an IAB donor 301.

Next, in step F702, the mobile IAB node 101 checks the received RRC Setup message, and in step F703, the mobile IAB node 101 determines whether the received message includes a communication permitted area format.

If the mobile IAB node 101 determines that the received message does not include a communication permitted area format (NO in step F703), the processing proceeds to step F708. In step F708, the mobile IAB node 101 follows other information included in the RRC Setup message. In this case, the mobile IAB node 101 performs the normal connection process after reception of the RRC Setup message as specified in TS 38.331.

If the mobile IAB node 101 determines that the received message includes a communication permitted area format (YES in step F703), the processing proceeds to step F704. In step F704, the mobile IAB node 101 determines whether the position of the IAB node 101 itself is inside the communication permitted area.

The position information of the IAB node 101 itself used for this determination is determined based on GPS information received via a GPS antenna control unit 107, a GPS communication unit 106, and a GPS signal reception unit 210. In addition, from the coordinate group indicated in the permitted area information stored in the received communication permitted area format, the mobile IAB node 101 extracts the range formed by connecting the coordinates as the communication permitted area and uses the same for this determination. The mobile IAB node 101 compares the position information of the IAB node 101 itself determined in the above process with the communication permitted area to determine whether the IAB node 101 itself is located inside or outside the communication permitted area.

If the mobile IAB node 101 determines that the position of the IAB node 101 itself is outside the permitted area (NO in step F704), the mobile IAB node 101 outside the area cannot provide service. Thus, in this case, in step F710, the mobile IAB node 101 notifies the IAB donor 301 of a connection failure and stops the processing related to the RRC Setup process specified in TS 38.331.

If the mobile IAB node 101 determines that the position of the IAB node 101 itself is inside the permitted area (YES in step F704), the processing proceeds to step F705. In step F705, the mobile IAB node 101 determines whether a permitted area information format 402 includes validity period information.

If the mobile IAB node 101 determines that the validity period information is not included (NO in step F705), determining whether the current time is within the validity period in step F706 is skipped, and the processing proceeds to next step F707.

If the mobile IAB node 101 determines that the validity period information is included (YES in step F705), the processing proceeds to step F706. In step F706, the mobile IAB node 101 determines whether the current time is within the validity period of the specified communication permitted area.

The current time information of the IAB node 101 itself used for this determination is determined based on GPS information received via the GPS antenna control unit 107, the GPS communication unit 106 and the GPS signal reception unit 210.

If the mobile IAB node 101 determines that the current time is not within the validity period of the designated communication area (NO in step F706), the mobile IAB node 101 is within the area but cannot provide services because the validity period has expired. In this case, in step F710, the mobile IAB node 101 notifies the IAB donor 301 of a connection failure, and stops the processing related to the RRC Setup specified in TS 38.331.

If the mobile IAB node 101 determines that the current time is within the validity period of the specified communication permitted area (YES in step F706), the mobile IAB node 101 performs the determination in step F707. That is, the mobile IAB node 101 determines whether the permitted area information format 402 includes wireless parameter information (high-level device) and wireless parameter information (low-level device) fields.

If the mobile IAB node 101 determines that the permitted area information format 402 does not include the wireless parameter information fields (NO in step F707), the mobile IAB node 101 determines that there are no restrictions on wireless parameters in the communication permitted area. In this case, in step F708, the mobile IAB node 101 performs the normal connection processing after reception of the RRC Setup message specified in TS 38.331 in accordance with other information included in the RRC Setup message.

If the mobile IAB node 101 determines that the wireless parameter information fields are included (YES in step F707), the mobile IAB node 101 applies the wireless parameter information (high-level device) and the wireless parameter information (low-level device) as wireless parameter constraints in the communication permitted area. In step F709, the mobile IAB node 101 performs a process of connection with the IAB donor 301 that is the high-level device, and provide a beacon broadcast to the UE that is the lower-level device. At this time, the wireless parameter information (high-level device) and the wireless parameter information (low-level device) linked to the permitted area information stored in the communication-permitted area format are used.

The above is the sequence of processing performed by the mobile IAB node 101 in the present embodiment at the time of reception of an RRC Setup message including communication permitted area information.

Although embodiments have been described in detail above, the present disclosure is not limited to the specific embodiments, and various modifications and changes are possible within the scope described in the claims. It is also possible to combine all or a plurality of components of the above-described embodiments.

For example, if the position of the IAB node 101 itself is outside the permitted communication area or if the current time is not within the validity period, the mobile IAB node 101 performs processing of not leaving or joining the network in steps F508, F608, and F710 so as not to provide services.

The mobile IAB node 101 does not necessarily have to not leave or join the network as a solution for not providing services. For example, the mobile IAB node 101 may maintain or establish a Backhaul Adaptation Protocol (BAP) connection with a high-level device typified by the IAB donor 301. In this case, the mobile IAB node 101 may perform processing of stopping service provision to a low-level device, such as a UE, while maintaining IAB behavior.

Although the position information of the IAB node 101 itself used in each processing is obtained by GPS, position information obtained by another positioning method represented by Wi-Fi positioning may also be used instead.

In the above-described embodiments, the time information acquired by GPS is used as the IAB node 101 itself time information, but the present disclosure is not limited to this. For example, a built-in clock function represented by a real-time clock (RTC), time information set via a network such as Network Time Protocol (NTP), time information set from a high-level device, or the like may be used.

In the above-described embodiments, the case has been exemplified in which the communication permitted area format 401 includes only a single piece of permitted area information. However, a plurality of pieces of permitted area information may also be set. In this case, for example, in the flowchart of processing in FIG. 5 at the time of reception of an RRC Setup message, the mobile IAB node 101 may repeat the determination processing from steps F503 to F505 the number of times equal to the number of pieces of permitted area information that have been set. This also applies to the processing in the flowcharts of FIGS. 6 and 7.

In the above-described embodiments, the case has been disclosed in which it is additionally determined whether the wireless parameter information (high-level device), the wireless parameter information (low-level device), and the validity period information, which are defined as optional information in FIG. 7, are included. In this case, in the processing in the flowchart, if it is determined in step F705 that the validity period information is not included, the processing proceeds to step F707. However, other modes are also possible. For example, if the mobile IAB node 101 determines that the validity period information is not included as the system behavior, in step F708, the mobile IAB node 101 performs the normal connection processing after reception of the RRC Setup message as specified in TS 38.331 according to other information included in the RRC Setup message. Alternatively, in step F710, the mobile IAB node 101 may notify the IAB donor 301 of a connection failure, and stops the processing related to the RRC Setup as specified in TS 38.331.

The following supplementary notes will also be provided regarding the above-described embodiments.

### Supplementary Note 1

A communication apparatus that functions as an Integrated Access and Backhaul (IAB) node, the communication apparatus including an acquisition unit configured to acquire position information of the communication apparatus, a reception unit configured to receive a control plane signal including area information, and a determination unit configured to determine whether to provide a communication service to another communication apparatus based on the acquired position information and the received area information.

### Supplementary Note 2

The communication apparatus according to Supplementary Note 1, wherein the control plane signal including the area information is a signal transmitted via an IAB donor of a connection destination.

### Supplementary Note 3

The communication apparatus according to Supplementary Note 1 or 2, wherein the control plane signal is a Radio Resource Control (RRC) message.

### Supplementary Note 4

The communication apparatus according to Supplementary Note 3, wherein the RRC message is an RRC Reconfiguration message or an RRC Setup message.

### Supplementary Note 5

The communication apparatus according to any one of Supplementary Notes 1 to 4, wherein the area information includes information indicating a set of coordinates consisting of latitude information and longitude information, wherein the position information includes information indicating longitude and latitude of the communication apparatus, and wherein the determination unit determines whether to provide the communication service to the other communication apparatus based on the longitude and latitude indicated by the position information and the set of coordinates included in the area information.

### Supplementary Note 6

The communication apparatus according to any one of Supplementary Notes 1 to 5 that further includes a change unit configured to, in a case where the control plane signal includes, in addition to the area information, information relating to a wireless setting to be used in an area indicated by the area information, change an operation setting of the communication apparatus based on the information relating to the wireless setting.

### Supplementary Note 7

The communication apparatus according to Supplementary Note 6, wherein the information relating to the wireless setting includes at least one of a data transmission/reception frequency, a beacon frequency, or transmission power information.

### Supplementary Note 8

The communication apparatus according to any one of Supplementary Notes 1 to 7, wherein provision of the communication service includes accepting an access from a user equipment (UE).

### Supplementary Note 9

A communication apparatus according to any one of Supplementary Notes 1 to 8, the communication apparatus further including a second acquisition unit configured to acquire time information indicating the current time, wherein, in a case where the control plane signal includes, in addition to the area information, a start time at which the provision of the communication service becomes possible in the area indicated by the area information and an end time at which the provision of the communication service in the area is to end, the determination unit further determines whether to provide the communication service to the other communication apparatus based on the start time, the end time, and the time information, in addition to the acquired position information and the received area information.

The present disclosure is not limited to the above-described embodiments, and various modifications and variations can also be made without departing from the spirit and scope of the present disclosure. Therefore, the following claims are appended to apprise the public of the scope of the present disclosure.

According to an aspect of the present disclosure, it is possible to provide a mechanism that allows a mobile IAB node to recognize each specific area.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non- transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus that functions as a mobile node, comprising:
an acquisition unit configured to acquire position information of the communication apparatus;
a reception unit configured to receive a control plane signal including area information; and
a determination unit configured to determine whether to provide a communication service to another communication apparatus based on the acquired position information and the received area information.

2. The communication apparatus according to claim 1, wherein the control plane signal including the area information is a signal transmitted via an Integrated Access and Backhaul (IAB) donor of a connection destination.

3. The communication apparatus according to claim 1, wherein the control plane signal is a Radio Resource Control (RRC) message.

4. The communication apparatus according to claim 3, wherein the RRC message is an RRC Reconfiguration message or an RRC Setup message.

5. The communication apparatus according to claim 1,
wherein the area information includes information indicating a set of coordinates consisting of latitude information and longitude information,
wherein the position information includes information indicating longitude and latitude of the communication apparatus, and
wherein the determination unit determines whether to provide the communication service to the other communication apparatus based on the longitude and latitude indicated by the position information and the set of coordinates included in the area information.

6. The communication apparatus according to claim 1, further comprising a change unit configured to, in a case where the control plane signal includes, in addition to the area information, information relating to a wireless setting to be used in an area indicated by the area information, change an operation setting of the communication apparatus based on the information relating to the wireless setting.

7. The communication apparatus according to claim 6, wherein the information relating to the wireless setting includes at least one of a data transmission/reception frequency, a beacon frequency, or transmission power information.

8. The communication apparatus according to claim 1, wherein provision of the communication service includes accepting an access from a user equipment (UE).

9. A communication apparatus according to claim 1, further comprising a second acquisition unit configured to acquire time information indicating a current time,
wherein, in a case where the control plane signal includes, in addition to the area information, a start time at which the provision of the communication service becomes possible in an area indicated by the area information and an end time at which the provision of the communication service in the area is to end, the determination unit further determines whether to provide the communication service to the other communication apparatus based on the start time, the end time, and the time information, in addition to the acquired position information and the received area information.

10. The communication apparatus according to claim 1, wherein the mobile node is a mobile IAB node.

11. A control method for controlling communication of a communication apparatus that functions as a mobile node, the control method comprising:
acquiring position information of the communication apparatus;
receiving a control plane signal including area information; and
determining whether to provide a communication service to another communication apparatus based on the acquired position information and the received area information.

12. A non-transitory storage medium storing a program for causing a computer to execute a control method comprising:
acquiring position information of a communication apparatus that functions as a mobile node;
receiving a control plane signal including area information; and
determining whether to provide a communication service to another communication apparatus based on the acquired position information and the received area information.
